(19) United States
(12) Patent Application Publication
(10) Pub. No.: US 2008/0254205 A1
(43) Pub. Date: Oct. 16, 2008

(54) SELF-INITIATED ALKALINE METAL ION FREE ELECTROLESS DEPOSITION COMPOSITION FOR THIN CO-BASED AND NI-BASED ALLOYS

(75) Inventors: Nicolai Petrov, Wallingford, CT (US); Charles Valverde, Ansonia, CT (US); Qingyun Chen, Branford, CT (US); Richard Hurtubise, Clinton, CT (US)

Correspondence Address: SENNIGER POWERS LLP, ONE METROPOLITAN SQUARE, 16TH FLOOR, ST LOUIS, MO, 63102, US

(73) Assignee: ENTHONE INC., West Haven, CT (US)

(21) Appl. No.: 11/735,202

(22) Filed: Apr. 13, 2007

(51) Int. Cl. B05D 5/12; C09D 5/00

(52) U.S. Cl. 427/99.5; 106/1.23

(57) ABSTRACT

A method and composition for electrolessly depositing a layer of a metal alloy onto a surface of a metal substrate in manufacture of microelectronic devices. The composition comprises a source of metal deposition ions, a borane-based reducing agent, and a two-component stabilizer, wherein the first stabilizer component is a source of hypophosphite and the second stabilizer component is a molybdenum (VI) compound.

### FIELD OF THE INVENTION

This invention relates to electroless plating of Co, Ni, and alloys thereof in microelectronic device applications.

### BACKGROUND OF THE INVENTION

Electroless deposition of Co and Ni is performed in a variety of applications in the manufacture of microelectronic devices. For example, Co is used in capping of damascene Cu metallization employed to form electrical interconnects in semiconductor integrated circuit device substrates. Copper can diffuse rapidly into a Si substrate and dielectric films such as, for example, SiO₂ or low-κ dielectrics. In the context of semiconductor integrated circuit device manufacture, substrates include patterned silicon wafers and dielectric films such as, for example, SiO₂ or low-κ dielectrics. Low-κ dielectric refers to a material having a smaller dielectric constant than silicon dioxide (dielectric constant of SiO₂=3.9). Low-κ dielectric materials are desirable since such materials exhibit reduced parasitic capacitance compared to the same thickness of SiO₂ dielectric, enabling increased feature density, faster switching speeds, and lower heat dissipation. Low-κ dielectric materials can be categorized by type (silicates, fluorosilicates and organo-silicates, organic polymeric etc.) and by deposition technique (CVD; spin-on). Dielectric constant reduction may be achieved by reducing polarizability, by reducing density, or by introducing porosity.

Copper can also diffuse into a device layer built on top of a substrate in multilayer device applications. Such diffusion can be detrimental to the device because it can cause electrical leakage in substrates, or form an unintended electrical connection between two interconnects resulting in an electrical short. Moreover, Cu diffusion out of an interconnect feature can disrupt electrical flow. Copper also has a tendency to migrate from one location to another when electrical current passes through interconnect features in service, creating voids and hillocks. This migration can damage an adjacent interconnect line and disrupt electrical flow in the feature where the metal migrates. Cobalt capping is employed to inhibit this Cu diffusion and migration.

Accordingly, among the challenges facing integrated circuit device manufacturers is to minimize diffusion and electromigration of metal in metal-filled interconnect features. This challenge becomes more acute as the devices further miniaturize, and as the features further miniaturize and densify.

Another challenge in the context of metal interconnect features is to protect them from corrosion. Certain interconnect metals, especially Cu, are more susceptible to corrosion. Copper is a fairly reactive metal which readily oxidizes under ambient conditions. This reactivity can undermine adhesion to dielectrics and thin films, resulting in voids and delamination. Another challenge is therefore to combat oxidation and enhance adhesion between the cap and the Cu, and between structure layers.

The industry has deposited Co-based caps over Cu and other metal interconnect features, as discussed in, for example, U.S. Pat. No. 7,008,872 and U.S. Pat. Pub. No. 2005/0275100.

A particular Co-based metal capping layer employed to reduce Cu migration, provide corrosion protection, and enhance adhesion between the dielectric and Cu is a ternary alloy including Co, W, and P. Another refractory metal may replace or be used in addition to W, and B is often substituted for or used in addition to P. Each component of the alloy imparts advantages to the protective layer.

A particular problem for the integration of this technology to current ULSI fabrication lines is high defectivity of the capping layer. In recent years, defectivity reduction has been an object in inventions relating to plating baths and tools. See Katakabe et al. (U.S. Pat. Pub. No. 2004/0245214), Kolics et al. (U.S. Pat. No. 6,911,067), Dubin et al. (U.S. Pat. Pub. No. 2005/0008786), Cheng et al. (U.S. Pat. Pub. No. 2004/0253814), Weidman et al. (U.S. Pat. Pub. No. 2005/0084615), Pancham et al. (U.S. Pat. Pub. No. 2005/0072525), and Saijo et al. (U.S. Pat. Pub. No. 2005/0009340). Defectivity reduction remains a challenge in ULSI fabrication lines.

Typical defects in electroless plated cobalt alloys for use as caps on interconnect features may be summarized as follows.

Nodulation: localized preferential growth or particle formation on the Cu deposit, at Cu/dielectric and Cu/barrier interfaces, and on dielectric surfaces. This problem may be generally caused by a lack of stability of the working bath, and formation of incubation centers in the solution, such as Co³⁺ due to the oxidation of Co²⁺ by dissolved oxygen.

Grain decoration: uneven morphology of electroless Co film along the Cu line that replicates Cu erosion before plating and/or unevenly grown Co film due to initiation delay at Cu grain interfaces. Such growth can contribute to overall deposit roughness.

Granularity: irregularly sized nanocrystallites and clusters of amorphous electroless deposits of Co and its alloys with large grains and well-defined grain interfaces. This type of morphology can contribute to surface roughness.

Non-uniform growth: varying deposit thickness along the Cu substrate due to different plating rate of electroless Co on different size features, features located in different areas, dense and isolated, and/or features with different surface areas.

Pitting: the formation of pits or pinholes due to localized incomplete Cu surface coverage or extensive hydrogen bubble formation during the deposition process of the electroless film.

Those defects decrease diffusion barrier effectiveness, lower the capability of the capping layer to suppress electromigration, cause electromigration failure, affect the signal propagation across the circuitry, increase current leakage, and may even result in electrical shorts.

Therefore, a need continues to exist for substantially defect free, uniform, and smooth electrolessly deposited capping layers over Cu interconnects.

### SUMMARY OF THE INVENTION

Among the various aspects of the invention may be noted a process for plating low defectivity Co-based and Ni-based caps over interconnect metallization in the manufacture of microelectronic devices using highly stabilized electroless deposition compositions.

Briefly, therefore, the invention is directed to a method for electrolessly depositing a layer of a metal alloy onto a surface of a metal substrate in manufacture of microelectronic devices. The method comprises contacting the metal substrate with an electroless deposition composition that causes electroless deposition of the layer of the metal alloy onto the surface of the metal substrate.

The invention is also directed to an electroless deposition composition. The composition comprises a source of metal deposition ions in an initial concentration which provides between about 2.5 g/L and about 20 g/L of said deposition ions; a borane-based reducing agent in an initial concentration between about 0.07 M and about 0.12 M for reducing the metal deposition ions to metal on the substrate; and a two-component stabilizer comprising a first stabilizer component and a second stabilizer component wherein the first stabilizer component is a source of hypophosphite in an initial concentration between about 0.006 M and about 0.024 M and the second stabilizer component is a molybdenum (VI) compound in an initial concentration between about 0.03 mM and about 1.5 mM; wherein the electroless deposition composition has a molar ratio of the initial concentration of borane-based reducing agent to the initial concentration of hypophosphite between about 3:1 and about 12:1.

Other objects and features of the invention will be in part apparent and in part pointed out hereinafter.

### BRIEF DESCRIPTION OF THE FIGURES

FIGS. 1A and 1B are SEM photographs of Co—W—B protective alloys layers plated from electroless Co deposition compositions according to the method of Example 7. FIG. 1A shows alloy layers deposited from a deposition composition not containing ammonium hypophosphite stabilizer. FIG. 1B shows alloy layers deposited from a deposition composition containing ammonium hypophosphite stabilizer.

FIGS. 2A and 2B are SEM photographs of Co—W—B protective alloys layers plated from electroless Co deposition compositions according to the method of Example 8. FIG. 2A shows alloy layers deposited from a deposition composition containing ammonium hypophosphite stabilizer (1 g/L). FIG. 2B shows alloy layers deposited from a deposition composition containing ammonium hypophosphite stabilizer (5 g/L).

FIGS. 3A and 3B are SEM photographs of Co—W—B protective alloys layers plated from electroless Co deposition compositions according to the method of Example 9. FIG. 3A shows alloy layers deposited from a deposition composition not containing ammonium dimolybdate stabilizer. FIG. 3B shows alloy layers deposited from a deposition composition containing ammonium dimolybdate stabilizer.

FIGS. 4A and 4B are SEM photographs of Co—W—B protective alloys layers plated from electroless Co deposition compositions according to the method of Example 10. FIG. 4A shows alloy layers deposited from a deposition composition not containing ammonium laureth sulfate surfactant. FIG. 4B shows alloy layers deposited from a deposition composition containing ammonium laureth sulfate surfactant.

### DETAILED DESCRIPTION OF THE PREFERRED EMBODIMENT(S)

In accordance with the method of the present invention, Co-based alloys and Ni-based alloys may be deposited from highly stable electroless deposition compositions which yield a uniform deposit with enhanced selectivity. The present invention stems from the discovery of components which act as stabilizers in the electroless deposition compositions. Stabilizers are additives which are added to an electroless plating composition to reduce spontaneous decomposition and uncontrollable precipitation of the metal in the volume of the solution. Stabilizers suppress nodular growth, stray growth on the dielectric, and extensive hydrogen evolution, thereby preventing pitting. The stabilizers of the present invention can be used in conjunction with known levelers, grain refiners, and surfactants in the electroless deposition composition to yield Co-based alloys and Ni-based alloys as low defectivity caps over interconnect metallization in the manufacture of microelectronic devices.

Stabilizers of the present invention include a source of hypophosphite, a source of molybdenum (VI), or a combination thereof.

Hypophosphite is a known reducing agent for cobalt ion and nickel ion, chosen in part because of its docile behavior compared to other reducing agents. When hypophosphite is chosen as the reducing agent, co-deposition of P yields a finished alloy containing phosphorus. In the electroless deposition compositions of the present invention, the hypophosphite is added in a relatively low initial concentration and functions as a stabilizer. That is, an electroless deposition composition comprising hypophosphite in the concentrations of the present invention exhibits enhanced stability, improved plating selectively of interconnect metallization in the microelectronic device substrates, suppressed stray deposition on the dielectric, and reduced initiation time to deposition. Without being bound by a particular theory, it is thought that hypophosphite, present at the low concentrations of the invention, oxidizes a portion of the borane-based reducing agent that otherwise may spontaneously decompose. By oxidizing a portion of the borane-based reducing agent, cobalt ion reduction in the deposition composition volume may be inhibited. When a source of hypophosphite is used as a stabilizer in the electroless deposition composition, elemental phosphorus appears in the cobalt or nickel alloy due to its reduction by the borane-based reducing agent.

Exemplary sources of hypophosphite include ammonium hypophosphite, phosphinic acid, anilinium hypophosphite, and tetrabutylammonium hypophosphite. Preferably, the source of hypophosphite is an alkali metal free source of hypophosphite. A preferred source of hypophosphite is ammonium hypophosphite.

The source of hypophosphite may be added in an initial concentration sufficient to yield a hypophosphite concentration of at least about 0.4 g/L, preferably at least about 0.75 g/L. The source of hypophosphite may be added in a concentration sufficient to yield a hypophosphite concentration no more than about 1.3 g/L, preferably no more than about 1.0 g/L. Accordingly, the source of hypophosphite may be added to yield a hypophosphite concentration between about 0.4 g/L and about 1.3 g/L hypophosphite, preferably between about 0.75 g/L and about 1.0 g/L, for example about 0.8 g/L. When ammonium hypophosphite is the source of hypophosphite stabilizer, ammonium hypophosphite may be added at a concentration between about 0.5 g/L (0.006M) and about 2.0 g/L (0.024M) ammonium hypophosphite, preferably between about 0.5 g/L (0.006M) and about 1.5 g/L (0.018M) ammonium hypophosphite, more preferably about 1 g/L (0.012M) ammonium hypophosphite. At concentrations less than about 0.5 g/L, the stabilization effect is not observed, and the cobalt plates as a brittle and black deposit with poor adhesion to the interconnect metallization. At concentrations greater than about 2 g/L, the electroless deposition composition can become too active, and deposition can become non-selective with cobalt metal forming spontaneously in the volume of the solution and on the dielectric material.

Molybdenum (VI) compounds may be added in addition to or in place of hypophosphite as an additional stabilizer in the electroless deposition compositions of the present invention. Molybdenum (VI) stabilizers appear to better enhance uniformity in the deposit. At higher concentration levels, it is observed that the addition of molybdenum (VI) compounds to the deposition composition reduces particle formation on the deposit and dielectric surfaces, thus improving the selectivity of the deposition composition. The addition of molybdenum (VI) stabilizers enhances stability. It has been observed that an electroless deposition composition containing molybdenum (VI) compounds as a stabilizer can be between about 5 to 7 times more stable than a comparable composition not containing molybdenum (VI) compounds as a stabilizer, as measured by a standard Pd stress test.

Exemplary sources of molybdenum (VI) compounds include molybdenum trioxide; molybdic acids; molybdic acid salts of ammonium, tetramethylammonium, and alkali metals; heteropoly acids of molybdenum; and other mixtures thereof. Molybdenum (VI) compounds include MoO₃ and salts of molybdic acid predissolved with TMAH, those include: (NH₄)₂MoO₄; (NH₄)₆Mo₇O₂₄.4H₂O; (NH₄)₆Mo₈O₂₇.4H₂O; dimolybdates (Me₂Mo₂O₇.nH₂O) such as (NH₄)₂Mo₂O₇.nH₂O; trimolybdates (Me₂Mo₃O₁₀.nH₂O) such as (NH₄)₂Mo₃O₁₀.2H₂O; tetramolybdates (Me₂Mo₄O₁₃); metamolybdates (Me₂H₁₀₋ₘ[H₂(Mo₂O₇)₆]nH₂O; wherein m is less than 10); hexamolybdates (Me₂Mo₆O₁₉.nH₂O); octamolybdates (Me₂Mo₈O₂₅.nH₂O); paramolybdates (Me₂Mo₇O₂₂.nH₂O and Me₁₀Mo₁₂O₄₁.nH₂O). In the above, Me is a counterion selected from among ammonium, tetramethylammonium, and alkali metal cations, and n is an integer having a value corresponding to a stable or metastable form of the hydrated oxide. Preferably, the source of molybdenum (VI) is an alkali metal free source of molybdenum oxide. A preferred molybdenum (VI) compound stabilizer is ammonium dimolybdate ((NH₄)₂Mo₂O₇.nH₂O).

The molybdenum (VI) compound stabilizers may be added in an initial concentration between about 0.03 mM and about 1.5 mM, such as about 0.6 mM; which typically corresponds to, for example, between about 0.01 g/L and about 1 g/L, such as about 0.2 g/L. When ammonium dimolybdate is the source of molybdenum oxide stabilizer, the ammonium dimolybdate may be added in concentrations of about 0.01 g/L (about 0.03 mM) to about 0.5 g/L (about 1.5 mM), such as about 0.2 g/L (about 0.6 mM).

In addition to their advantage as stabilizers, reduction of molybdenum ions from the molybdenum (VI) compound stabilizers can result in the co-deposition of elemental molybdenum into the Co or Ni alloy cap. The co-deposition of Mo from electroless deposition compositions comprising molybdenum oxides into the alloy cap is especially high, ranging from about 0.5 atomic % to about 12 atomic %. Advantageously, the thermal stability of the deposit is enhanced when Mo is co-deposited with W, a refractory metal commonly deposited into Co-based alloys. Additionally, it is thought that Mo co-deposition into the alloy cap functions to increase corrosion resistance and diffusion resistance.

The electroless deposition compositions of the present invention for electroless plating of Co or Ni alloys such as in a metal capping layer onto a metal-filled interconnect may additionally comprise a source of deposition ions, a reducing agent, and a complexing agent. The pH may be adjusted to and buffered within a certain pH range. Optionally, the bath may also comprise a source of refractory ions.

For the deposition of a Co-based alloy, the electroless deposition composition comprises a source of Co ions. In the context of capping electrical interconnects, Co-based alloys provide several advantages. They do not significantly alter the electrical conductivity characteristics of Cu. Cobalt provides good barrier and electromigration protection for Cu. Cobalt, which is selected in significant part because it is immiscible with Cu, does not tend to alloy with Cu during assembly or over time during service. The Co ions are introduced into the composition as an inorganic Co salt or a Co complex with an organic carboxylic acid.

Exemplary inorganic Co salts include cobalt hydroxide (Co(OH)₂), cobalt chloride hydrate (CoCl₂.nH₂O), cobalt chloride (CoCl₂), cobalt chloride hexahydrate (CoCl₂.H₂O), cobalt sulfate hydrate (COSO₄.nH₂O), cobalt sulfate heptahydrate (CoSO₄.7H₂O), and other suitable inorganic salts. Exemplary Co complexes with an organic carboxylic acids include cobalt acetate(Co(CH₃COO)₂), cobalt acetate tetrahydrate (Co(CH₃COO)₂.4H₂O), cobalt citrate, cobalt lactate, cobalt succinate, cobalt propionate, cobalt hydroxyacetate, and others. Preferred sources include cobalt hydroxide (Co(OH)₂), cobalt chloride hydrate (CoCl₂.nH₂O), cobalt chloride (CoCl₂), cobalt chloride hexahydrate (CoCl₂.6H₂O), cobalt acetate(Co(CH₃COO)₂), and cobalt acetate tetrahydrate (Co (CH₃COO)₂.4H₂O). Co(OH)₂ may be used where it is desirable to avoid overconcentrating the solution with Cl⁻ or other anions. Cobalt acetate and cobalt acetate tetrahydrate (Co(CH₃COO)₂.4H₂O) enhance the stability of the electroless Co deposition composition compared to a comparable electroless Co deposition composition using a Co source other than cobalt acetate.

In one embodiment, the Co salt or complex is added to provide at least about 1.0 g/L Co²⁺ ion to the electroless deposition composition, typically at least about 2.5 g/L Co²⁺ ion. The concentration may be as high as about 20.0 g/L, preferably no more than about 10 g/L Co²⁺ ion to yield a Co-based alloy of high Co metal content. In some applications, the Co content in the electroless bath is very low, for example, as low as between about 0.1 g/L and about 1.0 g/L of Co²⁺. In an exemplary composition, the source of Co²⁺ ions is cobalt chloride hexahydrate, which is added in a concentration between about 10 g/L and about 50 g/L to achieve a concentration of Co²⁺ ions between about 2.5 g/L (about 0.04M) and about 12.5 g/L (about 0.21M). Preferably, cobalt chloride hexahydrate is added in a concentration of about 30 g/L to achieve a concentration of Co²⁺ ions of about 7.5 g/L (about 0.13M). In another exemplary composition, the source of Co²⁺ ions is cobalt acetate tetrahydrate, which is added in a concentration between about 10 g/L and about 40 g/L to achieve a concentration of Co²⁺ ions between about 2.5 g/L (about 0.04M) and about 9.5 g/L (about 0.16M). Preferably, cobalt acetate tetrahydrate is added in a concentration of about 20 g/L to achieve a concentration of Co²⁺ ions of about 4.75 g/L (about 0.08M).

The electroless deposition composition can instead or additionally comprise a source of Ni²⁺ ions, typically at least about 2.5 g/L Ni²⁺ ion. Sources of Ni²⁺ ions include inorganic Ni salts such as chloride, sulfate, or other suitable inorganic salt, or a Ni complex with an organic carboxylic acid such as Ni acetate, citrate, lactate, succinate, propionate, hydroxyacetate, or others. Ni(OH)₂ may be used where it is desirable to avoid overconcentrating the solution with Cl⁻ or other anions.

In one embodiment, the Ni salt or complex is added to provide at least about 1 g/L Ni²⁺ ion to the electroless deposition composition. The concentration may be as high as about 20.0 g/L, preferably no more than about 10 g/L Ni²⁺ ion to yield a Ni-based alloy of high Ni metal content. In some applications, the Ni content in the electroless bath is very low, for example, as low as between about 0.1 g/L and about 1 g/L of Ni²⁺. In an exemplary composition, the source of Ni²⁺ ions is nickel chloride hexahydrate, which is added in a concentration between about 10 g/L and about 50 g/L to achieve a concentration of Ni²⁺ ions between about 2.5 g/L (about 0.04M) and about 12.5 g/L (about 0.21M). Preferably, nickel chloride hexahydrate is added in a concentration of about 30 g/L to achieve a concentration of Ni²⁺ ions of about 7.5 g/L (about 0.13M). In another exemplary composition, the source of Ni²⁺ ions is nickel acetate tetrahydrate, which is added in a concentration between about 10 g/L and about 40 g/L to achieve a concentration of Ni²⁺ ions between about 2.5 g/L (about 0.04M) and about 9.5 g/L (about 0.16M). Preferably, nickel acetate tetrahydrate is added in a concentration of about 20 g/L to achieve a concentration of Ni²⁺ ions of about 4.75 g/L (about 0.08M).

Preferred reducing agents include the borane-based reducing agents, which include methylamine borane, isopropyl amine borane, dimethylamine borane (DMAB, (CH₃)₂NHBH₃, also referred to as borane dimethylamine complex), diethyl amine borane (DEAB), trimethylamine borane, triethylamine borane, triisopropylamine borane, pyridine borane, morpholine borane, and others. A preferred borane-based reducing agent is DMAB. When a borane-based reducing agent is chosen, boron becomes part of the plated alloy. As is known, the deposition composition requires approximately equal molar amounts of the borane-based reducing agent to reduce Co²⁺ or Ni²⁺ ions into metallic Co or Ni, although there may be a limited excess of borane-based reducing agent. For example, the ratio of the molar concentration of borane-based reducing agent to the molar concentration of Co²⁺ ion can be between about 2:1 and about 1:2, such as about 1:1.

To ensure that a sufficient concentration of reducing agent for self-initiated deposition is present in the electroless deposition composition, dimethylamine borane, for example, is added in an initial concentration of at least about 3 g/L (about 0.05M), preferably at least about 4 g/L (about 0.07M). Although concentrations as low as about 3 g/L are applicable, initiation can be impractically slow at concentrations lower than about 4 g/L for commercially practical purposes. The initial concentration dimethylamine borane can be less than about 7 g/L (about 0.12M), preferably less than about 6 g/L (about 0.1M). At concentrations higher than about 7 g/L, the bath can become unstable and reduces cobalt and nickel ions non-selectively in the plating solution and on the dielectric material. Accordingly, the concentration is preferably kept below about 7 g/L. In an exemplary composition, the concentration is about 5 g/L (about 0.085M). Preferably, a ratio of the initial molar concentration of the borane-based reducing agent and the initial molar concentration of the source of hypophosphite is between about 3:1 to about 12:1, preferably between about 5:1 and about 10:1, such as about 7:1. Plating solutions with borane-based reducing agents do not need a copper surface activation step. Instead, the reducing agent catalyzes reduction of the metal ion onto the Cu surface.

Due to the oxidation of the reducing agent, B co-deposits with the Co or Ni. Effects of B co-deposition into the deposit are reduced grain size and enhanced amorphousness, which can render the microstructure more impervious to Cu diffusion and electromigration. For example, Co—W—B with high W content has an amorphous phase. Without being bound to a particular theory, it is believed that the presence of refractory metal together with B improves the barrier properties by filling in the grain boundaries of the crystalline structure of the deposit.

The electroless deposition composition may further contain agents for pH adjustment and buffering agents. The pH is typically controlled by one or more pH adjusters, and the composition typically contains a pH buffer to stabilize the pH within the desired pH range. In one embodiment, the desired pH range is between about 7.5 and about 10.0. In one embodiment, it is between about 8.0 and about 10, for example, between about 9.1 and about 9.3. Exemplary agents for pH adjustment include potassium hydroxide (KOH), tetramethylammonium hydroxide (TMAH, (CH₃)₄NOH), tetraethylammonium hydroxide (TEAH), tetrapropylammonium hydroxide (TPAH), tetrabutylammonium hydroxide (TBAH), ethyltrimethylammonium hydroxide (EMTAH), benzyltrimethylammonium hydroxide (BzTMAH), tetrabutylphosphonium hydroxide (TBPH), ammonia, and other amines. Exemplary buffering agents include, for example, boric acid, borate salts, tetraborates, pentaborates, phosphates, ammonia, and hydroxyl amines such as monoethanolamine, diethanolamine, triethanolamine, and ethylenediamine, among others. A preferred additive for pH adjustment is tetramethylammonium hydroxide. A preferred buffering agent is boric acid. The buffering agent can be added in an initial concentration between about 5 g/L and about 30 g/L, for example, about 15 g/L.

A complexing agent helps to keep Co ions in solution. Because the electroless deposition composition is typically buffered to a mildly alkaline pH of between about 7.5 and about 10.0, Co²⁺ ions have a tendency to form hydroxide salts and precipitate out of solution. Accordingly, complexing agents are added to the electroless deposition composition to increase the solubility of Co²⁺ ions. The complexing agents used in the composition are selected from among carboxylic acids and carboxylate salts such as citric acid (H₃C₆H₅O₇), acetic acid (CH₃COOH), acetate salts (especially alkaline metal free salts), malic acid, glycine, propionic acid, succinic acid, and lactic acid; alkanol amines such as methanolamine (MEA), diethanolamine (DEA), and triethanolamine (TEA); ammonium salts such as ammonium chloride, ammonium sulfate, and ammonium hydroxide; and inorganic chelating agents such as pyrophosphate and polyphosphate. Some complexing agents, such as cyanide, are avoided because they complex with Co ions too strongly and can prevent deposition from occurring.

In some compositions, ammonium-based complexing agents are avoided. Ammonia, being relatively volatile, has a tendency to evaporate from the plating bath at the elevated temperatures typical of electroless deposition. Moreover, ammonium has a tendency to etch copper, which introduces roughness into the overplated Co-based and Ni-based caps. Accordingly, some compositions of the present invention are free of or substantially free of ammonium. By “substantially free,” it is meant that there is some tolerance for ammonium in the composition, which may be introduced by the selection of certain components. However, the ammonium concentration added because of these components will be low, preferably less than about 0.4 g/L, more preferably less than about 0.3 g/L.

The electroless deposition composition may comprise more than one complexing agent, such as a primary complexing agent and a secondary complexing agent. For example, the composition can comprise citric acid as a primary complexing agent and acetic acid as a secondary complexing agent. Acetic acid is a preferred secondary complexing agent because it serves as an additional buffering agent and has brightening properties. If the source of cobalt ions is cobalt acetate, adding acetic acid as a secondary complexing agent may be unnecessary, and the cobalt deposition composition can comprise one complexing agent, such as citric acid.

The complexing agent concentration may be selected such that a ratio of the molar concentration of the complexing agent to the molar concentration of the Co²⁺ ion is between about 2:1 and about 10:1. Depending on the complexing agent molecular weight, the level of complexing agent may be on the order of between about 10 g/L and about 200 g/L. For example, citric acid may be used in a concentration range between about 40 g/L (about 0.21M) and about 150 g/L (about 0.78M), preferably about 80 g/L (about 0.42M). Citric acid may be coupled with acetic acid as a secondary complexing agent. The acetic acid may be added in a concentration between about 0.01 g/L and about 30 g/L (about 0.5M), such as about 6 g/L (about 0.1M).

If desired, the electroless deposition composition may also include a refractory metal ion, such as W or Re, which functions to increase the deposited alloy's thermal stability, corrosion resistance, and diffusion resistance. Exemplary sources of W ions are tungsten trioxide, tungstic acids, ammonium tungstic acid salts, tetramethylammonium tungstic acid salts, and alkali metal tungstic acid salts, phosphotungstic acid, silicotungstate, other heteropolytungstic acids, and combinations thereof. The concentration of the source of tungsten preferably provides a concentration of tungsten in the electroless deposition composition between about 1 g/L and about 10 g/L, such as about 3 g/L. For example, the electroless deposition composition may contain between about 1 g/L and about 20 g/L of tungstic acid to provide between about 4 mM and about 0.08M tungsten in the composition. Preferably, about 4 g/L tungstic acid is added to provide about 16 mM tungsten. Other sources of refractory metal include rhenium (VIII) oxides, perrhenic acids, ammonium perrhenic acid salts, tetrabutylammonium perrhenic acid salts, alkali metal perrhenic acid salts, heteropolyacids of rhenium, and other mixtures thereof.

The concentration of the source of rhenium preferably provides a concentration of rhenium ion in the electroless deposition composition between about 0.2 g/L and about 3.5 g/L, such as about 0.3 g/L. For example, the electroless deposition composition may contain between about 0.05 g/L and about 5 g/L of ammonium perrhenate to provide between about 0.2 mM and about 0.02M rhenium in the composition. Preferably, about 0.3 g/L ammonium perrhenate is added to provide about 1 mM rhenium.

Other additives, as are known in the art such as levelers, stabilizers, surfactants, and grain refiners may also be added.

At low concentrations, hydrazine and/or hydrazine-based compounds can be added as levelers, as disclosed in U.S. patent application Ser. No. 11/085,304. Levelers act with the stabilizer of the invention to further enhance deposition morphology and topography, and also to control the deposition rate. Examples of preferred sources of hydrazine include hydrazine (NH₂NH₂), hydrazine hydrate, hydrazine sulfate, hydrazine chloride, hydrazine bromide, hydrazine dihydrochloride, hydrazine dihydrobromide, and hydrazine tartrate. These sources are preferred in certain embodiments of the invention because they provide hydrazine directly upon dissolution. Other suitable sources of hydrazine include 2-hydrazinopyridine, hydrazobenzene, phenyl hydrazine, hydrazine-N,N-diacetic acid, 1,2-diethylhydrazine, monomethylhydrazine, 1,1-dimethylhydrazine, 1,2-dimethylhydrazine, 4-hydrazinobenzenesulfonic acid, hydrazinecarboxylic acid, 2-hydrazinoethanol, semicarbazide, carbohydrazide, aminoguanidine hydrochloride, 1,3-diaminoguanidine monohydrochloride, and triaminoguanidine hydrochloride. These sources provide hydrazine as a reaction product. According to the electroless deposition compositions of the present invention, the hydrazine or its derivatives are added to the bath in a relatively low concentration range of about 1 mg/L to about 1000 mg/L, preferably from about 1 mg/L to about 100 mg/L, such as about 10 mg/L.

Oximes may be added to the electroless deposition composition as stabilizers, as disclosed in U.S. patent application Ser. No. 11/148,724. Advantageously, when oxime-based compounds are added to Co-based electroless deposition compositions, the stabilizers reduce stray deposition of Co or Co alloys onto the dielectric and reduce the formation of Co-based nodules in the deposited cap. Exemplary oxime-based compound stabilizers for use in the compositions of the present invention include ketoximes and aldoximes. Ketoximes are commonly formed by a condensation reaction between ketones and hydroxylamine or hydroxylamine derivatives. Exemplary ketoximes include dimethylglyoxime (DMG, CH₃C(═NOH)C(═NOH)CH₃) and 1,2-cyclohexanedione dioxime. Aldoximes are commonly formed by a condensation reaction between aldehydes and hydroxylamine or hydroxylamine derivatives. Exemplary aldoximes include salicylaldoxime and syn-2-pyridinealdoxime. According to the compositions of the present invention, the oxime-based stabilizers can be added to the composition in a relatively low concentration range of about 1 mg/L to about 1000 mg/L, preferably from about 1 mg/L to about 100 mg/L, such as about 10 mg/L.

Surfactants, as disclosed in U.S. patent application Ser. No. 11/243,624, for use in the electroless deposition compositions of certain embodiments of the present invention include: diphenyl oxide disulfonic acids such as Calfax 10LA-75; triethanolamine salts of lauryl sulfate such as Calfoam TLS-40; ammonium laureth sulfates such as Calfoam EA 603; alkylbenzene sulfonates such as Calsoft L-40C and Calsoft AOS-40; dodecylbenzene sulfonic acids such as Calsoft LAS-99; alkyldiphenyloxide disulfonate salts such as Dowfax 3b2; soluble, low molecular weight polypropylene glycol containing compounds such as PPG 425; and soluble polyethylene glycol polymers such as PEG 200, PEG 300, PEG 400, and PEG 600. In these descriptions of the polypropylene glycol and polyethylene glycol surfactants, the number designates the approximate molecular weight. Accordingly, the polyethylene glycol surfactant may have a molecular weight between about 200 g/mol and about 600 g/mol, such as about 200 g/mol, about 300 g/mol, about 400 g/mol, and about 600 g/mol.

These surfactants are effective in reducing surface roughness and improving uniformity in the deposited alloy, without the negative effect of particle or nodule formation. In the compositions of the invention, the concentration of the surfactant may be between about 10 mg/L and about 800 mg/L, preferably between about 100 mg/L and about 300 mg/L. For example, Calfoam EA 603 may be added in a concentration between about 10 mg/L and about 500 mg/L, for example, about 300 mg/L. Calfoam EA 603 is a high foam forming surfactant, so this surfactant is especially useful where the tool platform uses a low solution flow rate. In another example, PEG 600 may be added in a concentration of about 10 mg/L and about 600 mg/L, for example, about 200 mg/L. PEG 600 is a non-foam forming surfactant, so this is a useful surfactant for tool platforms where foaming may be detrimental.

In some applications, the electroless deposition composition is substantially sodium free, or alkali metal ion free. Moreover, the electroless deposition composition components may also be selected to yield a composition which is substantially free of ammonium, as explained above.

The electroless deposition composition may be prepared by mixing together three compositions, prepared separately: a cobalt ion and/or nickel ion solution, a stabilizer solution, and a reducing agent solution. Separate solutions are prepared to increase their shelf life. For example, metal ions and reducing agents cannot be stored together in a single solution for an extended duration because the solution will decompose due to metal ion reduction. The three separate solutions are preferably mixed immediately prior to use.

The cobalt ion and/or nickel ion solution may comprise a source of cobalt ions and/or nickel ions, a complexing agent, a buffering agent, a source of refractory metal ions, a pH adjusting agent, and, if present in the final composition, a hydrazine leveler and an oxime-based stabilizer. The stabilizer solution may comprise a complexing agent, a buffering agent, a source of hypophosphite, a source of molybdenum oxide, a pH adjusting agent, a surfactant, and, if present in the final composition, a hydrazine leveler and an oxime-based stabilizer. The reducing agent solution may comprise a reducing agent and a pH adjusting agent.

The solutions described above may be mixed together to prepare the electroless deposition composition. Preferably, the solutions are mixed together according to a preset volume ratio. For example, the electroless deposition composition may be prepared by adding 10 volume parts of the cobalt solution, 10 volume parts of the stabilizer solution, and 1 volume part of the reducing agent solution. For example, a 210 mL bath can be prepared by adding 100 mL cobalt ion solution, 100 mL stabilizer solution, and 10 mL of reducing agent solution. The concentrations of each component in each solution are adjusted to reflect the dilution factor as the three separately prepared solutions are mixed together to achieve the preferred concentrations in the final electroless deposition composition. For example, the cobalt ion concentration in the cobalt ion solution is about 2× the final concentration in the electroless deposition composition. Components such as the hydrazine leveler and the oxime-based stabilizer, because they are present in both the cobalt ion solution and the stabilizer solution, are each added to the precursor solutions in approximately the same concentration as the final concentration of each in the electroless deposition composition. The reducing agent concentration in the reducing agent solution may be about 20× the concentration of the final electroless deposition composition.

Employing the foregoing baths, a variety of alloys can be deposited. For example, Co diffusion barrier layers include Co—W—P, Co—W—B, Co—W—B—P, Co—B—P, Co—B, Co—Mo—B, Co—W—Mo—B, Co—W—Mo—B—P, and Co—Mo—P, Co—Re—P, Co—Re—B, Co—Re—B—P, Co—W—Re—P, Co—W—Re—B, Co—W—Re—B—P, Co—Re—Mo—P, Co—Re—Mo—B, Co—Re—Mo—B—P, Co—W—Re—Mo—P, Co—W—Re—Mo—B, Co—W—Re—Mo—B—P, among others. Ni diffusion barrier layers include Ni—Co—P, Ni—Mo—P, Ni—Mo—B—P, Ni—Co—B, and Ni—Co—Mo—B—P, Ni—Re—P, Ni—Re—B, Ni—Re—B—P, Ni—W—Re—P, Ni—W—Re—B, Ni—W—Re—B—P, Ni—Re—Mo—P, Ni—Re—Mo—B, Ni—Re—Mo—B—P, Ni—W—Re—Mo—P, Ni—W—Re—Mo—B, Ni—W—Re—Mo—B—P, among others.

According to the practice of electroless deposition, a layer of cobalt or nickel alloy may be deposited by exposure of the electroless deposition compositions to, for example, a patterned silicon dioxide or low-K dielectric substrate having vias and trenches, in which a metal layer, such as Cu, has already filled into the vias or trenches. This exposure may comprise dip, flood immersion, spray, or other manner of exposing the substrate to a deposition composition, with the provision that the manner of exposure adequately achieves the objectives of depositing a metal layer of the desired thickness and integrity.

In applications where the invention is used for capping, surface preparation may be needed for removing organic residues left by CMP and for dissolving Cu oxide from the Cu surface. Unless removed, the oxide can interfere with adhesion of the cap and can detract from electrical conductivity.

Acidic pretreatment involves exposing the substrate to an acid selected from among HCl, H₂SO₄, citric acid, methanesulfonic acid, and H₃PO₄ to remove CMP residues, Cu oxides, and Cu embedded in the dielectric by CMP. After the acidic pretreatment operation is completed, the substrate is rinsed by, e.g., DI water.

Alternatively or additionally, an alkaline pretreatment employs basic cleaner for removing oxide from the metal interconnect feature. This cleaner preferably removes all the oxide, for example copper oxide, without removing substantial amounts of the metallization in the interconnects. Typical basic cleaners contain TMAH with addition of hydroxylamine, MEA, TEA, EDA (ethylenediamine), or DTA (diethylenetriamine) at pH range of 9 to 12. A water rinse follows the alkaline pretreatment.

The electroless deposition composition of the present invention may be used in a conventional continuous mode deposition process. In the continuous mode, the same volume is used to treat a large number of substrates. In this mode, reactants must be periodically replenished, and reaction products accumulate, necessitating periodic removal of the deposition composition. Preferably, in this mode, the composition contains an initially high concentration of metals ions for depositing onto the substrate. Alternatively, the electroless deposition composition of the present invention is also suited for a so-called “use-and-dispose” deposition process. In the use-and-dispose mode, the deposition composition is used to treat a substrate, and then the composition volume is directed to a waste stream. Although this latter method may be more expensive, the use and dispose mode requires no metrology, that is, measuring and adjusting the solution composition to maintain stability is not required. It is advantageous from a cost perspective to use lower concentrations of metal ions when working in “use-and-dispose” mode.

For auto-catalyzation of the electroless deposition, borane-based reducing agents may be employed such as, for example monomethyl amine borane, isopropyl amine borane, dimethylamine borane (DMAB), diethyl amine borane (DEAB), trimethylamine borane, triethylamine borane, triisopropylamine borane, pyridine borane, morpholine borane, and mixtures thereof. Oxidation/reduction reactions involving the borane-based reducing agents and Co alloy or Ni alloy deposition ions are catalyzed by Cu. In particular, at certain plating conditions, e.g., pH and temperature, the reducing agents are oxidized in the presence of Cu, thereby reducing the deposition ions to metal which deposits on the Cu. The process is preferably substantially self-aligning in that the metal is deposited essentially only on the Cu interconnect. However, in many instances, stray Co is deposited onto the dielectric. When the stabilizers of the present invention are added to the composition, the electroless deposition composition deposits a smooth and level Co alloy or Ni alloy capping layer with substantially reduced stray deposition on the dielectric.

As an alternative, certain embodiments of the invention employ an electroless deposition process which does not employ a reducing agent which renders Cu catalytic to metal deposition. For such processes a surface activation operation is employed to facilitate subsequent electroless deposition. A currently preferred surface activation process utilizes a Pd immersion reaction. Other known catalysts are suitable and include Rh, Ru, Pt, Ir, and Os. Alternatively, the surface may be prepared for electroless deposition by seeding as with, for example, Co seeding deposited by electroless deposition, electrolytic deposition, PVD, CVD, or other technique as is known in the art.

Deposition typically occurs at a composition temperature of between about 50° C. to about 90° C., such as about 55° C. If the temperature is too low, the reduction rate is too low, and at a low enough temperature, Co reduction does not initiate at all. At too high a temperature, the deposition rate increases, and the bath can become too active. For example, Co reduction can become less selective, and Co deposition may occur not just on the Cu interconnect features of a wafer substrate, but also on the dielectric material. Further, at very high temperatures, Co reduction can occur spontaneously within the deposition composition volume and on the sidewalls of the plating tank. Deposition rates achievable using the electroless deposition compositions of the present invention may be between about 50 Å/minute and about 100 Å/minute. Deposition typically occurs for between about 1 minute and about 3 minutes. Accordingly, Co and Ni alloy capping layers having thicknesses between 50 Å and about 300 Å are routinely achieved, which capping layers are substantially defect free, uniform, and smooth as electrolessly deposited.

Optionally, the capping layers can be subjected to a post deposition cleaning to improve the yield.

The following examples further illustrate the present invention.

### EXAMPLE 1

### Preparation of Cobalt Ion Solution

A cobalt ion solution was prepared having the following components and concentrations on a per Liter basis:
(1) CoCl₂.6H₂O (Cobalt chloride hexahydrate, 60 g/L, 0.252M)
(2) H₃C₆H₅O₇ (Citric acid, 80 g/L, 0.38M)
(3) CH₃COOH (Acetic acid, 12 g/L, 0.2M)
(4) H₃BO₃ (Boric acid, 15 g/L, 0.24M)
(5) H₂WO₄ (Tungstic acid, 8 g/L, 0.032M)
(6) NH₂NH₂ (Hydrazine, 10 mg/L)
(7) CH₃C(═NOH)C(=NOH)CH₃ (Dimethylglyoxime, 10 mg/L)
(8) (CH₃)₄N(OH) (Tetramethylammonium hydroxide (TMAH), added in an amount sufficient to yield pH 9.1).

This solution was prepared according to the following protocol:
(1) Citric acid, acetic acid and boric acid were dissolved in distilled water.
(2) Cobalt chloride predissolved in distilled water was added to the solution containing citric acid, acetic acid, and boric acid.
(3) TMAH was added to increase pH of the solution to about 5.
(4) Tungstic acid predissolved in TMAH solution was added to the solution containing cobalt chloride, citric acid, acetic acid, and boric acid.
(5) Hydrazine and dimethylglyoxime were added to the mixture.
(6) The pH was adjusted to about 9.1 with TMAH.
(7) The final volume was achieved by adding distilled water.
(8) The solution was filtered through 0.05 μm filter.

### EXAMPLE 2

### Preparation of Cobalt Solution

An alternative cobalt ion solution was prepared having the following components and concentrations on a per Liter basis:
(1) Co(CH₃COO)₂.4H₂O (Cobalt acetate tetrahydrate, 40 g/L, 0.16M)
(2) H₃C₆H₅O₇ (Citric acid, 80 g/L, 0.38M)
(3) H₃BO₃ (Boric acid, 15 g/L, 0.24M)
(4) H₂WO₄ (Tungstic acid, 8 g/L, 0.032M)
(5) NH₂NH₂ (Hydrazine, 10 mg/L)
(6) CH₃C(═NOH)C(═NOH)CH₃ (Dimethylglyoxime, 10 mg/L)
(7) (CH₃)₄N(OH) (Tetramethylammonium hydroxide (TMAH), added in an amount sufficient to yield pH 9.1).

This solution was prepared according to the following protocol:
(1) Citric acid and boric acid were dissolved in distilled water.
(2) Cobalt acetate predissolved in distilled water was added to the solution containing citric acid and boric acid.
(3) TMAH was added to increase pH of the solution to about 5.
(4) Tungstic acid predissolved in TMAH was added to the solution containing cobalt acetate, citric acid, and boric acid.
(5) Hydrazine and dimethylglyoxime were added to the mixture.
(6) The pH was adjusted to about 9.1 with TMAH.
(7) The final volume was achieved by adding distilled water.
(8) The solution was filtered through 0.05 μm filter.

### EXAMPLE 3

### Preparation of Stabilizer Solution

A stabilizer solution was prepared having the following components and concentrations on a per Liter basis:
(1) H₃C₆H₅O₇ (Citric acid, 80 g/L, 0.38M)
(2) H₃BO₃ (Boric acid, 15 g/L, 0.24M)
(3) NH₄H₂PO₂ (Ammonium hypophosphite, 2 g/L, 0.024M)
(4) (NH₄)₂Mo₂O₇ (Ammonium dimolybdate, 0.2 g/L, 0.0012M)
(5) NH₂NH₂ (Hydrazine, 10 mg/L)
(6) CH₃C(═NOH)C(=NOH)CH₃ (Dimethylglyoxime, 10 mg/L)
(7) (CH₃)₄N(OH) (Tetramethylammonium hydroxide, added in an amount sufficient to yield pH 9.1)
(8) Calfoam EA 603 (Ammonium Laureth Sulfate, 0.6 g/L)
(9) PEG-600 (Polyethylene glycol, 0.4 g/L).

This solution was prepared according to the following protocol:
(1) Citric acid, boric acid, ammonium hypophosphite, and ammonium dimolybdate were dissolved in distilled water.
(2) Hydrazine and dimethylglyoxime were added to the solution containing citric acid, boric acid, ammonium hypophosphite and ammonium dimolybdate.
(3) Surfactants were added to the solution.
(4) The pH was adjusted to about 9.1 with TMAH.
(5) The final volume was achieved by adding distilled water.
(6) The solution was filtered through 0.05 μm filter.

### EXAMPLE 4

### Preparation of Reducing Agent Solution

A reducing agent solution was prepared having the following components and concentrations on a per Liter basis:
(1) (CH₃)₂NHBH₃ (Borane dimethylamine complex, 100 g/L, 1.7M)
(2) (CH₃)₄N(OH) (Tetramethylammonium hydroxide, added in an amount sufficient to yield pH 9.1).

### EXAMPLE 5

### Preparation of Electroless Co Deposition Composition

An electroless Co deposition composition was prepared using the solutions from Examples 1, 3, and 4. The composition was prepared according to a volume ratio using 10 volume parts of the cobalt ion solution from Example 1 (100 mL), 10 volume parts of the stabilizer solution from Example 3 (100 mL), and 1 volume part of the reducing agent solution of Example 4 (10 mL). Accordingly, the electroless Co deposition composition contained the following components and approximate concentrations on a per Liter basis:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 5 g/L, 0.085M)
(6) H₂WO₄ (Tungstic acid, 4 g/L, 0.016M)
(7) NH₄H₂PO₂ (Ammonium hypophosphite, 1 g/L, 0.012M)
(8) (NH₄)₂Mo₂O₇ (Ammonium dimolybdate, 0.2 g/L, 0.0006M)
(9) NH₂NH₂ (Hydrazine, 10 mg/L)
(10) CH₃C(═NOH)C(═NOH)CH₃ (Dimethylglyoxime, 10 mg/L)
(11) (CH₃)₄N(OH) (Tetramethylammonium hydroxide, added in an amount sufficient to yield pH 9.1)
(12) Calfoam EA 603 (Ammonium Laureth Sulfate, 0.3 g/L)
(13) PEG-600 (Polyethylene glycol, 0.2 g/L).

### EXAMPLE 6

### Preparation of Electroless Co Deposition Composition

An electroless Co deposition composition was prepared using the solutions from Examples 2, 3, and 4. The composition was prepared according to a volume ratio using 10 volume parts of the cobalt ion solution from Example 2 (100 mL), 10 volume parts of the stabilizer solution from Example 3 (100 mL), and 1 volume part of the reducing agent solution of Example 4 (10 mL). Accordingly, the electroless Co deposition composition contained the following components and concentrations on a per Liter basis:
(1) Co(CH₃COO)₂.4H₂O (Cobalt acetate tetrahydrate, 20 g/L, 0.08M)
(2) H₃C₆H₅O₇ (Citric acid, 80 g/L, 0.38M)
(3) H₃BO₃ (Boric acid, 15 g/L, 0.24M)
(4) (CH₃)₂NHBH₃ (Borane dimethylamine complex, 5 g/L, 0.085M)
(5) H₂WO₄ (Tungstic acid, 4 g/L, 0.016M)
(6) NH₄H₂PO₂ (Ammonium hypophosphite, 1 g/L, 0.012M)
(7) (NH₄)₂Mo₂O₇ (Ammonium dimolybdate, 0.2 g/L, 0.0006M)
(8) NH₂NH₂ (Hydrazine, 10 mg/L)
(9) CH₃C(═NOH)C(═NOH)CH₃ (Dimethylglyoxime, 10 mg/L)
(10) (CH₃)₄N(OH) (Tetramethylammonium hydroxide, added in an amount sufficient to yield pH 9.1)
(11) Calfoam EA 603 (Ammonium Laureth Sulfate, 0.3 g/L)
(12) PEG-600 (Polyethylene glycol, 0.2 g/L).

### EXAMPLE 7

### Electroless Deposition of Co—W—B alloys From Electroless Deposition Compositions With and Without Ammonium Hypophosphite Stabilizer

Co—W—B alloys were deposited from electroless deposition compositions A and B having the following components and concentrations on a per Liter basis:

Deposition Composition A:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 2 g/L, 0.085M)
(6) H₂WO₄ (Tungstic acid, 4 g/L, 0.016M)
(7) (CH₃)₄N(OH) (Tetramethylammonium hydroxide, added in an amount sufficient to yield pH 9.1).

Deposition Composition B:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 2 g/L, 0.085M)
(6) H₂WO₄ (Tungstic acid, 4 g/L, 0.016M)
(7) NH₄H₂PO₂ (Ammonium hypophosphite, 1 g/L, 0.012M)
(8) (CH₃)₄N(OH) (Tetramethylammonium hydroxide, added in an amount sufficient to yield pH 9.1).

The deposition compositions A and B were used to deposit ternary Co—W—B alloys over exposed patterned Cu wires embedded in Ta/TaN stack barrier surrounded with interlevel dielectric (ILD) made of SiO₂-based material. The Cu wires had a width on the order of 150 nm, and after CMP, the Cu surface was lower than the surrounding dielectric. The surface roughness was about 5 Å to about 7 Å.

The patterned Cu substrates were exposed to a preclean solution of 1% sulfuric acid to remove post-CMP inhibitor residues, copper (II) oxide layer, and post-CMP slurry particles from ILD. They were then rinsed in deionized (DI) water, and subsequently activated with Pd. The Cu substrates were then rinsed in deionized (DI) water.

To deposit alloys, the substrates were immersed in the deposition compositions A and B. The baths were kept at 55° C., at a pH of about 9.1, and deposition occurred for 1 minute.

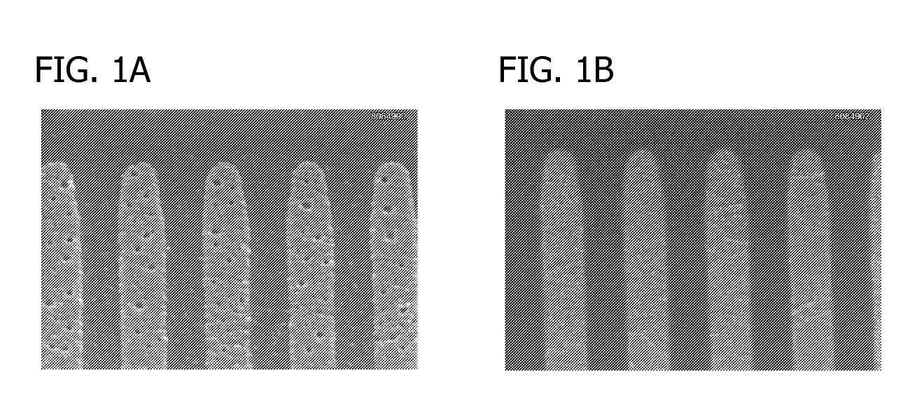

FIG. 1A depicts ternary Co—W—B alloys over exposed patterned Cu wires deposited from deposition composition A. FIG. 1B depicts ternary Co—W—B alloys over exposed patterned Cu wires deposited from deposition composition B, which is comparable to deposition composition A except for the addition of ammonium hypophosphite in a concentration of about 1 g/L. It can be seen that the alloy deposited from deposition composition B is smoother, has less pitting, and has less stray deposition than the alloy deposited from deposition composition A. The roughness of the alloy deposited from deposition composition A was between 1 Å and 20 Å while the roughness of the alloy deposited from deposition composition B was between 5 Å and 10 Å.

### EXAMPLE 8

### Electroless Deposition of Co—W—B alloys From Electroless Deposition Compositions With Varying Ammonium Hypophosphite Stabilizer Concentrations

Co—W—B alloys were deposited from electroless deposition compositions A and B having the following components and concentrations on a per Liter basis:

Deposition Composition A:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 5 g/L, 0.085M)
(6) H₂WO₄ (Tungstic acid, 4 g/L, 0.016M)
(7) NH₄H₂PO₂ (Ammonium hypophosphite, 1 g/L, 0.012M)
(8) (CH₃)₄N(OH) (Tetramethylammonium hydroxide, added in an amount sufficient to yield pH 9.1).

Deposition Composition B:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 5 g/L, 0.085M)
(6) H₂WO₄ (Tungstic acid, 4 g/L, 0.016M)
(7) NH₄H₂PO₂ (Ammonium hypophosphite, 5 g/L, 0.012M)
(8) (CH₃)₄N(OH) (Tetramethylammonium hydroxide, added in an amount sufficient to yield pH 9.1).

The deposition compositions A and B were used to deposit ternary Co—W—B alloys over exposed patterned Cu wires embedded in Ta/TaN stack barrier surrounded with interlevel dielectric (ILD) made of SiO₂-based material. The Cu wires had a width on the order of 150 nm, and after CMP, the Cu surface was lower than the surrounding dielectric. The surface roughness was between about 5 Å and about 7 Å.

The patterned Cu substrates were exposed to a preclean solution of 1% sulfuric acid to remove post-CMP inhibitor residues, copper (II) oxide layer, and post-CMP slurry particles from ILD. They were then rinsed in deionized (DI) water, and subsequently activated with Pd. The Cu substrates were then rinsed in deionized (DI) water.

To deposit alloys, the substrates were immersed in the deposition compositions A and B. The baths were kept at 55° C., at a pH of about 9.1, and deposition occurred for 1 minute.

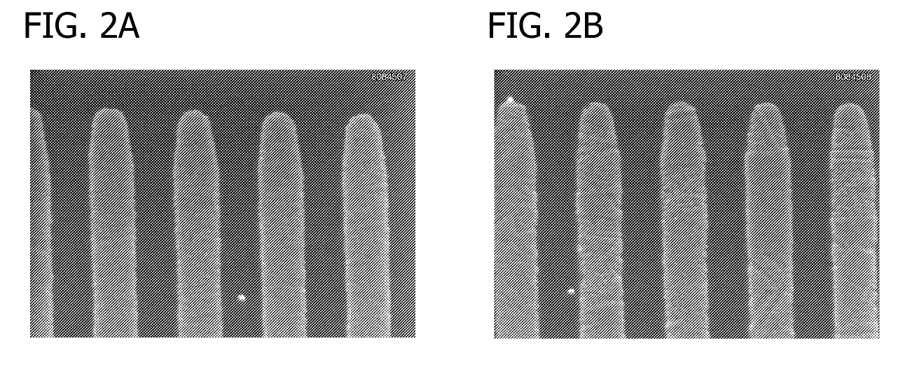

FIG. 2A depicts ternary Co—W—B alloys over exposed patterned Cu wires deposited from deposition composition A. FIG. 2B depicts ternary Co—W—B alloys over exposed patterned Cu wires deposited from deposition composition B, which is comparable to deposition composition A except for the higher ammonium hypophosphite concentration (1 g/L in composition A compared to 5 g/L in composition B). It can be seen that the alloy deposited from deposition composition B exhibits a greater degree of etching compared to the alloy deposited from deposition composition A.

### EXAMPLE 9

### Electroless Deposition of Co—W—B Alloys From Electroless Deposition Compositions With and Without Ammonium Dimolybdate Stabilizer

Co—W—B alloys were deposited from electroless deposition compositions A and B having the following components and concentrations on a per Liter basis:

Deposition Composition A:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 5 g/L, 0.085M)
(6) H₂WO₄ (Tungstic acid, 4 g/L, 0.016M)
(7) (CH₃)₄N(OH) (Tetramethylammonium hydroxide, added in an amount sufficient to yield pH 9.1).

Deposition Composition B:
(2) CoCl₂.6H₂O (Cobalt chloride hexahydrate, 30 g/L, 0.126M)
(3) H₃C₆H₅O₇ (Citric acid, 80 g/L, 0.38M)
(4) CH₃COOH (Acetic acid, 6 g/L, 0.1M)
(5) H₃BO₃ (Boric acid, 15 g/L, 0.24M)
(6) (CH₃)₂NHBH₃ (Borane dimethylamine complex, 5 g/L, 0.085M)
(7) H₂WO₄ (Tungstic acid, 4 g/L, 0.016M)
(8) (NH₄)₂Mo₂O₇ (Ammonium dimolybdate, 0.2 g/L)
(9) (CH₃)₄N(OH) (Tetramethylammonium hydroxide, added in an amount sufficient to yield pH 9.1).

The deposition compositions A and B were used to deposit ternary Co—W—B alloys over exposed patterned Cu wires embedded in Ta/TaN stack barrier surrounded with interlevel dielectric (ILD) made of SiO₂-based material. The Cu wires had a width on the order of 150 nm, and after CMP, the Cu surface was lower than the surrounding dielectric. The surface roughness was between about 5 Å and about 7 Å.

The patterned Cu substrates were exposed to a preclean solution of 1% sulfuric acid to remove post-CMP inhibitor residues, copper (II) oxide layer, and post-CMP slurry particles from ILD. They were then rinsed in deionized (DI) water, and subsequently activated with Pd. The Cu substrates were then rinsed in deionized (DI) water.

To deposit alloys, the substrates were immersed in the deposition compositions A and B. The baths were kept at 55° C., at a pH of about 9.1, and deposition occurred for 1 minute.

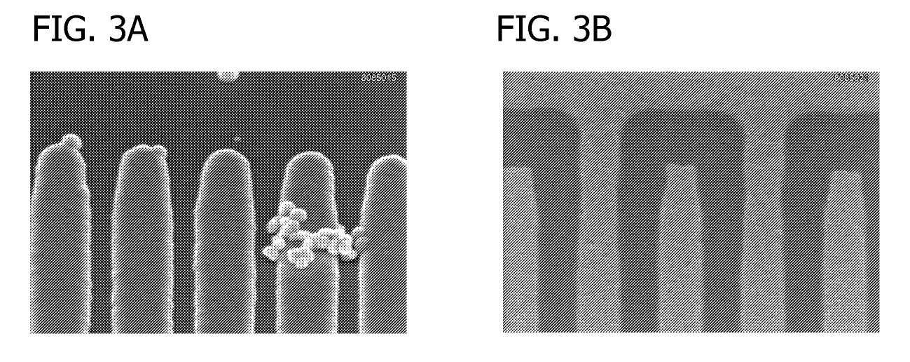

FIG. 3A depicts ternary Co—W—B alloys over exposed patterned Cu wires deposited from deposition composition A. FIG. 3B depicts ternary Co—W—B alloys over exposed patterned Cu wires deposited from deposition composition B, which is comparable to deposition composition A except for the addition of ammonium dimolybdate. It can be seen that the alloy deposited from deposition composition A is characterized by a severe lack of selectivity and stability as shown by the substantial stray deposition and modulation, in particular on the ternary alloy located second from the right in FIG. 3A. The addition of ammonium dimolybdate yielded the substantially more selective and smoother deposit shown in FIG. 3B.

### EXAMPLE 10

### Electroless Deposition of Co—W—B Alloys From Electroless Deposition Compositions With and Without Surfactant

Co—W—B alloys were deposited from electroless deposition compositions A and B having the following components and concentrations on a per Liter basis:

Deposition Composition A:
(2) CoCl₂.6H₂O (Cobalt chloride hexahydrate, 30 g/L, 0.126M)
(3) H₃C₆H₅O₇ (Citric acid, 80 g/L, 0.38M)
(4) CH₃COOH (Acetic acid, 6 g/L, 0.1M)
(5) H₃BO₃ (Boric acid, 15 g/L, 0.24M)
(6) (CH₃)₂NHBH₃ (Borane dimethylamine complex, 5 g/L, 0.085M)
(7) H₂WO₄ (Tungstic acid, 4 g/L, 0.016M)
(8) NH₄H₂PO₂ (Ammonium hypophosphite, 1 g/L, 0.012M)
(9) (CH₃)₄N(OH) (Tetramethylammonium hydroxide, added in an amount sufficient to yield pH 9.1).

Deposition Composition B:
(1) CoCl₂.6H₂O (Cobalt chloride hexahydrate, 30 g/L, 0.126M)
(2) H₃C₆H₅O₇ (Citric acid, 80 g/L, 0.38M)
(3) CH₃COOH (Acetic acid, 6 g/L, 0.1M)
(4) H₃BO₃ (Boric acid, 15 g/L, 0.24M)
(5) (CH₃)₂NHBH₃ (Borane dimethylamine complex, 5 g/L, 0.085M)
(6) H₂WO₄ (Tungstic acid, 4 g/L, 0.016M)
(7) NH₄H₂PO₂ (Ammonium hypophosphite, 1 g/L, 0.012M)
(8) Calfoam EA 603 (Ammonium Laureth Sulfate, 0.3 g/L)
(9) (CH₃)₄N(OH) (Tetramethylammonium hydroxide, added in an amount sufficient to yield pH 9.1).

The deposition compositions A and B were used to deposit ternary Co—W—B alloys over exposed patterned Cu wires embedded in Ta/TaN stack barrier surrounded with interlevel dielectric (ILD) made of SiO₂-based material. The Cu wires had a width on the order of 150 nm, and after CMP, the Cu surface was lower than the surrounding dielectric. The surface roughness was between about 5 Å and about 7 Å.

The patterned Cu substrates were exposed to a preclean solution of 1% sulfuric acid to remove post-CMP inhibitor residues, copper (II) oxide layer, and post-CMP slurry particles from ILD. They were then rinsed in deionized (DI) water, and subsequently activated with Pd. The Cu substrates were then rinsed in deionized (DI) water.

To deposit alloys, the substrates were immersed in the deposition compositions A and B. The baths were kept at 55° C., at a pH of about 9.1, and deposition occurred for 1 minute.

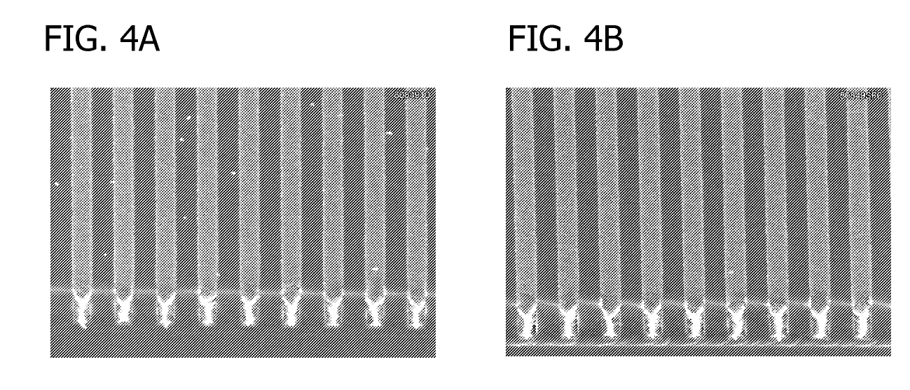

FIG. 4A depicts ternary Co—W—B alloys over exposed patterned Cu wires deposited from deposition composition A. FIG. 4B depicts ternary Co—W—B alloys over exposed patterned Cu wires deposited from deposition composition B, which is comparable to deposition composition A except for the addition of Calfoam EA 603 surfactant. It can be seen that the alloy deposited from deposition composition A is characterized by less selectivity, as shown by the present of stray deposition on the dielectric, than the alloy deposited from deposition composition B.

### EXAMPLE 11

### Stability Testing of Electroless Deposition Compositions Using Standard Pd Stress Testin

Stability testing was performed according to a standard Pd stress test procedure that is used for electroless Ni plating chemistries. The test electroless deposition composition had the following components and concentrations on a per Liter basis:
(1) CoCl₂.6H₂O (30 g/L)
(2) H₃C₆H₅O₇ (80 g/L)
(3) CH₃OOH (6 g/L)
(4) H₃BO₃ (15 g/l)
(5) H₂WO₄ (4 g/L)
(6) (CH₃)₂NHBH₃ (5 g/L)
(7) (CH₃)₄N(OH) (Tetramethylammonium hydroxide, added in an amount sufficient to yield pH 9.1).

The standard Pd stress test was performed according to the following protocol:
(1) The test electroless Co deposition composition (800 mL) was heated to the operating temperature (55° C.).
(2) A palladium solution (2 mL) comprising PdCl₂ (0.1 g/l) and HCl (4 mL/L of 50% solution) was added to the test composition every minute and stirred, until the test composition decomposed, as evinced by gas evolution and metal precipitation in the solution volume.
(3) Record time interval until test composition became unstable.

The time until decomposition measures solution stability and a parameter referred to as “stability titer,” which is calculated by multiplying the time until decomposition by 2. The test electroless deposition composition having none of the stabilizer additives of the invention remained stable for 5 minutes. Additional solutions were tested, each having one or more of the stabilizers of the invention. The results of the Pd stress test are shown in the following table:

| | Stability |
|---|---|
| Solution composition | time |
| Test composition with added NH₄H₂PO₂ (1 g/L) | 6 min. |
| Test composition with added NH₄H₂PO₂ (1 g/L) and | 6 min. |
| Calfoam EA 603 (0.3 g/L) | |
| Test composition with added NH₄H₂PO₂ (1 g/L), Calfoam | 30 min. |
| EA 603 (0.3 g/L), and (NH₄)₂Mo₂O₇ (0.2 g/L) | |
| Test composition with added NH₄H₂PO₂ (1 g/L), Calfoam | 50 min. |
| EA 603 (0.3 g/L), and (NH₄)₂Mo₂O₇ (0.2 g/L), and | |
| Co(CH₃COO)₂•4H₂O (20 g/L) was used as the Co ion | |
| source in place of CoCl₂•6H₂O | |

It can be seen that the addition of ammonium hypophosphite enhanced solution stability by 20%. The addition of ammonium dimolybdate stabilizer enhanced the solution stability by about 5 times. When cobalt acetate was used instead of cobalt chloride, the composition exhibited greatly enhanced stability.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. For example, that the foregoing description and following claims refer to “an” interconnect means that there are one or more such interconnects. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

We claim:

1. A method for electrolessly depositing a layer of a Co or Ni alloy onto a surface of a metal substrate in manufacture of microelectronic devices, the method comprising:
contacting the metal substrate with an electroless deposition composition that causes electroless deposition of the layer of the alloy onto the surface of the metal substrate, the electroless deposition composition comprising:
a source of metal deposition ions selected from the group consisting of Co ions and Ni ions in an initial concentration which provides between about 2.5 g/L and about 20 g/L of said deposition ions;
a borane-based reducing agent in an initial concentration between about 0.07 M and about 0.12 M for reducing the deposition ions to metal on the substrate; and
a two-component stabilizer comprising a first stabilizer component and a second stabilizer component wherein the first stabilizer component is a source of hypophosphite in an initial concentration between about 0.006 M and about 0.024 M and the second stabilizer component is a molybdenum (VI) compound in an initial concentration between about 0.03 mM and about 1.5 mM;
wherein the electroless deposition composition has a molar ratio of the initial concentration of borane-based reducing agent to the initial concentration of hypophosphite between about 3:1 and about 12:1.

2. The method of claim 1 wherein the metal deposition ions are cobalt ions.

3. The method of claim 1 wherein the metal deposition ions are nickel ions.

4. The method of claim 2 wherein the source of hypophosphite is alkali metal free.

5. The method of claim 2 wherein the source of hypophosphite is selected from the group consisting of ammonium hypophosphite, phosphinic acid, anilinium hypophosphite, tetrabutylammonium hypophosphite, and combinations thereof.

6. The method of claim 2 wherein the hypophosphite has an initial concentration between about 0.006 M and about 0.018 M.

7. The method of claim 2 wherein the molybdenum (VI) compound is ammonium dimolybdate in an initial concentration between about 0.01 g/L and about 0.5 g/L.

8. The method of claim 2 wherein the source of metal deposition ions has an initial concentration which provides between about 2.5 g/L and about 12.5 g/L cobalt ions.

9. The method of claim 2 wherein the electroless deposition composition comprises:
cobalt chloride hexahydrate, as said source of metal deposition ions, in an initial concentration to provide between about 2.5 g/L and about 12.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M; and
ammonium dimolybdate, as the molybdenum (VI) compound;
wherein said molar ratio of the initial concentration of borane-based reducing agent to the initial concentration of hypophosphite is between about 5:1 and about 10:1.

10. The method of claim 2 wherein the electroless deposition composition comprises:
cobalt acetate tetrahydrate, as said source of metal deposition ions, in an initial concentration to provide between about 2.5 g/L and about 9.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M; and
ammonium dimolybdate, as the molybdenum (VI) compound;
wherein said molar ratio of the initial concentration of borane-based reducing agent to the initial concentration of hypophosphite is between about 5:1 and about 10:1.

11. The method of claim 3 wherein the electroless deposition composition comprises:
nickel chloride hexahydrate, as said source of metal deposition ions, in an initial concentration to provide between about 2.5 and about 12.5 g/L Ni²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M; and
ammonium dimolybdate, as the molybdenum (VI) compound;
wherein said molar ratio of the initial concentration of borane-based reducing agent to the initial concentration of hypophosphite is between about 5:1 and about 10:1.

12. The method of claim 3 wherein the electroless deposition composition comprises:
nickel acetate tetrahydrate, as said source of metal deposition ions, in an initial concentration to provide between about 2.5 and about 9.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M; and
ammonium dimolybdate, as the molybdenum (VI) compound;
wherein said molar ratio of the initial concentration of borane-based reducing agent to the initial concentration of hypophosphite is between about 5:1 and about 10:1.

13. The method of claim 2 wherein the electroless deposition composition comprises:
cobalt chloride hexahydrate, as said source of metal deposition ions, in an initial concentration to provide between about 2.5 g/L and about 9.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M;
ammonium dimolybdate, as the molybdenum (VI) compound;
citric acid in an initial concentration between about 40 g/L and about 150 g/L;
acetic acid in an initial concentration between about 0.01 g/L and about 30 g/L;
tungstic acid in an initial concentration between about 1 g/L and about 20 g/L;
boric acid in an initial concentration between about 5 g/L and about 30 g/L, for example.

14. The method of claim 13, wherein the electroless deposition composition further comprises:
hydrazine or derivative thereof in an initial concentration between about 1 mg/L and about 100 mg/L; and
ammonium laureth sulfate in an initial concentration between about 10 mg/L and about 500 mg/L.

15. The method of claim 2 wherein the electroless deposition composition further comprises ammonium laureth sulfate in an initial concentration between about 10 mg/L and about 500 mg/L.

16. The method of claim 3 wherein the electroless deposition composition further comprises ammonium laureth sulfate in an initial concentration between about 10 mg/L and about 500 mg/L.

17. An electroless deposition composition for electrolessly depositing a Co or Ni alloy coating onto a metal substrate in manufacture of microelectronic devices, the electroless deposition composition comprising:
a source of deposition ions selected from the group consisting of Co ions and Ni ions in an initial concentration which provides between about 2.5 g/L and about 20 g/L of said deposition ions;
a borane-based reducing agent in an initial concentration between about 0.07 M and about 0.12 M for reducing the metal deposition ions to metal on the substrate;
a two-component stabilizer comprising a first stabilizer component and a second stabilizer component wherein the first stabilizer component is a source of hypophosphite in an initial concentration between about 0.006 M and about 0.024 M and the second stabilizer component is a molybdenum (VI) compound in an initial concentration between about 0.03 mM and about 1.5 mM; and
wherein the electroless deposition composition has a molar ratio of the initial concentration of borane-based reducing agent to the initial concentration of hypophosphite between about 3:1 and about 12:1.

18. The electroless deposition composition of claim 17 comprising:
cobalt acetate tetrahydrate, as said source of metal deposition ions, in an initial concentration to provide between about 2.5 g/L and about 9.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M; and
ammonium dimolybdate, as the molybdenum (VI) compound;
wherein said molar ratio of the initial concentration of borane-based reducing agent to the initial concentration of hypophosphite is between about 5:1 and about 10:1.

19. The electroless deposition composition of claim 17 comprising:
cobalt chloride hexahydrate, as said source of metal deposition ions, in an initial concentration to provide between about 2.5 g/L and about 12.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M; and
ammonium dimolybdate, as the molybdenum (VI) compound;
wherein said molar ratio of the initial concentration of borane-based reducing agent to the initial concentration of hypophosphite is between about 5:1 and about 10:1.

20. The electroless deposition composition of claim 17 comprising:
cobalt chloride hexahydrate, as said source of metal deposition ions, in an initial concentration to provide between about 2.5 g/L and about 9.5 g/L Co²⁺ ions;
DMAB, as said source of borane-based reducing agent, in an initial concentration between about 0.07 M and about 0.1 M;
ammonium hypophosphite, as said first stabilizer component wherein the first stabilizer component, in an initial concentration between about 0.006 M and about 0.018 M;
ammonium dimolybdate, as the molybdenum (VI) compound;
citric acid in an initial concentration between about 40 g/L and about 150 g/L;
acetic acid in an initial concentration between about 0.01 g/L and about 30 g/L;
tungstic acid in an initial concentration between about 1 g/L and about 20 g/L;
boric acid in an initial concentration between about 5 g/L and about 30 g/L, for example.

21. The electroless deposition composition of claim 17 further comprising:
hydrazine or derivative thereof in an initial concentration between about 1 and about 100 mg/L; and
ammonium laureth sulfate in an initial concentration between about 10 mg/L and about 500 mg/L.

22. A method for electrolessly depositing a layer of a Co or Ni alloy onto a surface of a metal substrate in manufacture of microelectronic devices, the method comprising:
contacting the metal substrate with the electroless deposition composition of claim 17 to cause electroless deposition of the layer of the alloy onto the surface of the metal substrate.
